(19) United States
(12) Patent Application Publication
(10) Pub. No.: US 2013/0232139 A1
(43) Pub. Date: Sep. 5, 2013

(54) ELECTRONIC DEVICE AND METHOD FOR GENERATING RECOMMENDATION CONTENT

(71) Applicants: YU-KAI XIONG, Shenzhen (CN); XIN LU, Shenzhen (CN); SHIH-FANG WONG, New Taipei (TW); HUI-FENG LIU, Shenzhen (CN); YU-YONG ZHANG, Shenzhen (CN); JIAN-JIAN ZHU, Shenzhen (CN); DONG-SHENG LV, Shenzhen (CN); XIANG-LIN CHENG, Shenzhen (CN); XIAO-SHAN ZHOU, Shenzhen (CN); XUAN-FEN HUANG, Shenzhen (CN); AN-LIN JIANG, Shenzhen (CN); XIN-HUA LI, Shenzhen (CN)

(72) Inventors: YU-KAI XIONG, Shenzhen (CN); XIN LU, Shenzhen (CN); SHIH-FANG WONG, New Taipei (TW); HUI-FENG LIU, Shenzhen (CN); YU-YONG ZHANG, Shenzhen (CN); JIAN-JIAN ZHU, Shenzhen (CN); DONG-SHENG LV, Shenzhen (CN); XIANG-LIN CHENG, Shenzhen (CN); XIAO-SHAN ZHOU, Shenzhen (CN); XUAN-FEN HUANG, Shenzhen (CN); AN-LIN JIANG, Shenzhen (CN); XIN-HUA LI, Shenzhen (CN)

(21) Appl. No.: 13/684,251

(22) Filed: Nov. 23, 2012

(30) Foreign Application Priority Data
Mar. 2, 2012 (CN) 201210052834.8

(51) Int. Cl. G06F 17/30

(52) U.S. Cl. CPC G06F 17/30979
USPC 707/723

(57) ABSTRACT

An electronic device includes a database, a display, and several program modules executable by a processor. The program modules include a query receiving module to receive a search query from a user, a query analyzing module to analyze the received search query and determine a content of interest associated with the search query and associated content associated with the content of interest. Also include are a search module to search for the content of interest and associated content associated with the content of interest in the database, a sorting module to sort the search results retrieved by the search module according to the number of times that the search has been conducted before, and a result presenting module to present the sorted search results according to a screen size of the display.

### BACKGROUND

1. Technical Field

The present disclosure relates to an electronic device and method for generating recommendation content.

2. Description of Related Art

Products, services, subscriptions, and other offerings are available via online sites. Online sites can provide recommendations of similar or related products based on what other customers have purchased or viewed. Nonetheless, these generic recommendations may not be effective to persuade a visitor to the online site to make a purchase. For example, the use of generic recommendations can often produce lists of recommendations that are too long to be useful to the visitor. Hence, there is a need for an improved system and method of providing recommendations.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of an electronic device in accordance with an embodiment.

FIG. 2 is a flow chart of a method for creating a recommendation list in response to a query received by the electronic device of FIG. 1 in accordance with an embodiment.

### DETAILED DESCRIPTION

Embodiments of the present disclosure will be described with reference to the accompanying drawings.

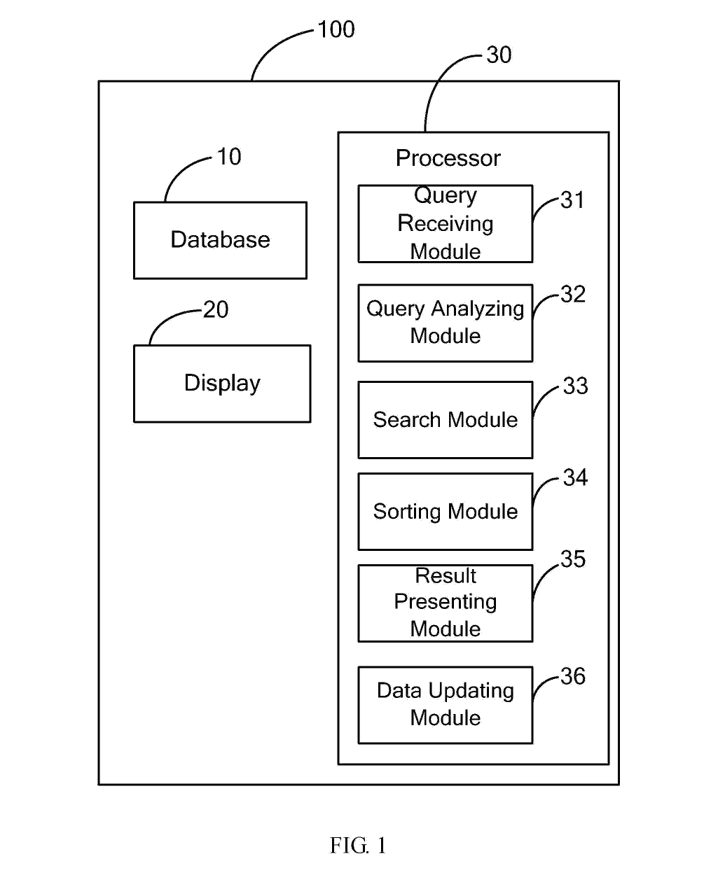

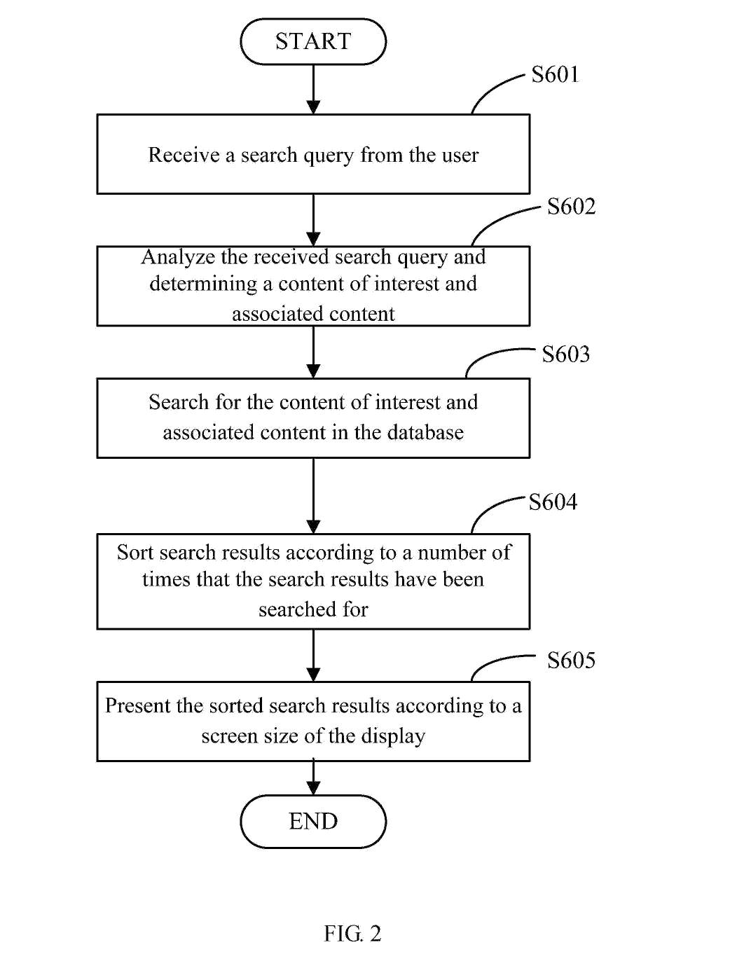

Referring to FIGS. 1 and 2, an electronic device 100 having recommendation capability using collaborative filtering includes a database 10, a display 20, and a processor 30. The processor 30 includes a query receiving module 31, a query analyzing module 32, a search module 33, a sorting module 34, and a result presenting module 35.

The query receiving module 31 receives a search query from a user. The query analyzing module 32 analyzes the received search query and determines content of interest associated with the search query and associated content associated with the content of interest. In one embodiment, the electronic device 100 is used as a server for an online store, and the query analyzing module 32 determines the content of interest based on the transaction record of the user. For example, if the transaction record of a user includes a tablet computer and a search query is “screen protector,” the query analyzing module 32 determines the content of interest is a screen protector for the tablet computer. The query analyzing module 32 also determines that the associated content related to the tablet computer includes a protective case for the tablet computer.

The search module 33 searches for the content of interest and associated content associated with the content of interest in the database 10. The sorting module 34 sorts the search results retrieved by the search module 33 according to the number of times that the search has been conducted before. Alternatively or optionally, the sorting module 34 may refine the sorted search results according to the times that particular results of the search results have been clicked/selected before. The result presenting module 35 presents the sorted search results according to the screen size of the display 20.

Alternatively or optionally, the search module 33 may search for the content of interest and associated content associated with the content of interest on the Internet and/or a local area network (if available). In this instance, the processor 30 may further include a data updating module 36 for adding the search results from the Internet and/or a local area network to the database 10.

FIG. 2 shows a flow chart of a method implemented by the electronic device 10. In step S601, the query receiving module 31 receives a search query from a user. In step S602, The query analyzing module 32 analyzes the received search query and determines a content of interest associated with the search query and associated content associated with the content of interest. In step S603, the search module 33 searches for the content of interest and associated content associated with the content of interest in the database 10. In step S604, the sorting module 34 sorts the search results retrieved by the search module 33 according to the number of the times that the search has been conducted before. In step S605, the result presenting module 35 presents the sorted search results according to the screen size of the display 20.

The method may further include the following step: the search module 33 searches for the content of interest and associated content associated with the content of interest on the Internet and/or a local area network (if available), and the data updating module 36 adds the search results from the Internet and/or a local area network to the database 10.

While various embodiments have been described and illustrated, the disclosure is not to be construed as being limited thereto. Various modifications can be made to the embodiments by those skilled in the art without departing from the true spirit and scope of the present disclosure as defined by the appended claims.

What is claimed is:

1. An electronic device, comprising:
a database;
a display;
a processor; and
a plurality of program modules executable by the processor, the program modules comprising:
a query receiving module to receive a search query from a user;
a query analyzing module to analyze the received search query and determine a content of interest associated with the search query and associated content associated with the content of interest;
a search module to search for the content of interest and associated content associated with the content of interest in the database;
a sorting module to sort the search results retrieved by the search module according to the number of times that the search has been conducted before; and
a result presenting module to present the sorted search results according to a screen size of the display.

2. The electronic device according to claim 1, wherein the sorting module is able to refine the sorted search results according to the number of times that particular results of the search results have been selected before.

3. The electronic device according to claim 1, wherein the search module is able to search for the content of interest and associated content associated with the content of interest on the Internet and/or a local area network.

4. The electronic device according to claim 3, further comprising a data updating module for adding the search results from the Internet and/or a local area network to the database.

5. The electronic device according to claim 1, being utilized as a server for an online store, wherein the query analyzing module determines the content of interest based on a transaction record of the user.

6. A method for creating a recommendation list in response to a query received by an electronic device from a user, the electronic device comprising a database, a display, and a processor, the method comprising:
receiving a search query from the user;
analyzing the received search query and determining a content of interest associated with the search query and associated content associated with the content of interest;
searching for the content of interest and associated content associated with the content of interest in the database;
sorting search results according to the number of times that the search has been conducted before; and
presenting the sorted search results according to a screen size of the display.

7. The method according claim 6, further comprising:
refining the sorted search results according to the number of times that particular items of the search results have been selected before.

8. The method according claim 6, further comprising:
searching for the content of interest and associated content associated with the content of interest on the Internet and/or a local area network.

9. The method according claim 8, further comprising:
adding the search results from the Internet and/or a local area network to the database.
